(19) United States
(12) Patent Application Publication
(10) Pub. No.: US 2023/0397583 A1
(43) Pub. Date: Dec. 14, 2023

(54) OCEAN SPECIES HARVESTING DEVICE

(71) Applicant: Worcester Polytechnic Institute, Worcester, MA (US)

(72) Inventors: Slater Campbell, Lincoln, MA (US); Abigail Leonardi, North Hampton, NH (US); Mark Gagliardi, Somerset, MA (US)

(21) Appl. No.: 18/209,625

(22) Filed: Jun. 14, 2023

Related U.S. Application Data
(60) Provisional application No. 63/351,914, filed on Jun. 14, 2022.

(51) Int. Cl. A01K 69/08; B63B 22/06

(52) U.S. Cl. CPC A01K 69/08; B63B 22/06

(57) ABSTRACT

A delayed release device for a buoy engaged with an underwater lobster trap operates with a first magnet securing a buoy, such that the buoy is tethered to a deployed lobster trap submerged in lobster harvesting regions of the ocean. A second magnet secures the first magnet based on a magnetic field, and a displacement actuator is in communication with the second magnet for retracting the magnet in response to a predetermined condition. Based on the condition, such as a time delay, the actuator moves the second magnet distal from the first magnet for releasing the buoy when the distance reduces the magnetic field sufficiently. The actuator may include a drive screw having a threaded engagement with the second magnet, such that the drive screw is responsive to rotation for retracting the second magnet.

### RELATED APPLICATIONS

This patent application claims the benefit under 35 U.S.C. § 119(e) of U.S. Provisional Patent App. No. 63/351,914, filed Jun. 14, 2022, entitled “OCEAN SPECIES HARVESTING DEVICE,” incorporated herein by reference in entirety.

### BACKGROUND

Environmental restrictions are becoming increasingly burdensome for lobster harvesting by restricting the use of underwater traps. Lobster traps are placed on the ocean bottom with a tethered buoy floating on the surface for subsequent retrieval. Unfortunately, the tethered buoy lines can present hazards for ocean species, and in particular, Atlantic Right Whales, which can become entangled in the lines. The restrictions reduce the duration and number of tethered lines for traps, which reduces the efficiency and effectiveness of the lobster harvesting industry.

### SUMMARY

A delayed release device for a buoy engaged with an underwater lobster trap operates with a first magnet securing a buoy, such that the buoy is tethered to a deployed lobster trap submerged in lobster harvesting regions of the ocean. A second magnet secures the first magnet based on a magnetic field, and a displacement actuator is in communication with the second magnet for retracting the magnet in response to a predetermined condition. Based on the condition, such as a time delay, the actuator moves the second magnet distal from the first magnet for releasing the buoy when the distance reduces the magnetic field sufficiently. The actuator may include a drive screw having a threaded engagement with the second magnet, such that the drive screw is responsive to rotation for retracting the second magnet.

Configurations herein are based, in part, on the observation that harvesting of bottom-feeding ocean species such as lobster, crab and shrimp often employs a submersible harvesting containment such as a so-called “lobster trap.” The trap has an array of one-way passages towards a bait chamber to which access can be gained, however retreat is very difficult, if not impossible, for a clawed species. Periodic harvesting is facilitated through a buoy tethered to the trap to enable subsequent retrieval. Unfortunately, conventional approaches to submerged harvesting containments, or traps. suffer from the shortcoming that the tether line rises through the depth to the buoy on the surface, presenting a hazard for other ocean species that may become tangled in the tether. A further drawback is that the trap containing the harvested species is also lost.

Accordingly, configurations herein substantially overcome the shortcomings of conventional tethered buys by providing a time release buoy that remains submerged with the trap until a prescribed time just before harvesting. In contrast to conventional approaches, the buoy and tether do not present an entanglement hazard for an indefinite time prior to trap recovery.

An example of the disclosed system for releasing a lobster trap buoy utilizes two permanent magnets, a motor, and a timer system. The buoy is fixed to the magnet by a short rope, and the magnet sits on the top surface of the waterproof enclosure. The secondary magnet is located within the enclosure, pressed against the top surface. The two magnets in conjunction with a lever generate a holding force strong enough to keep the buoy attached to the enclosure. Upon actuation at a predetermined time, the secondary magnet withdraws responsive to a threaded attachment on a rotating shaft, which disposes the secondary magnet sufficiently distal from the buoy (primary) magnet to cause the magnetic force securing the buoy magnet to fall below the buoyancy force exhibited by the buoy, releasing the buoy to float to the surface. A recovery rope of sufficient length attaches the buoy to the trap for recovery of the trap and contents.

In further detail, a buoy release device for an underwater harvesting apparatus includes a tether release securing a tether between a buoy and a submersible harvesting containment such as a lobster trap, and a magnet disposed in magnetic communication with the tether release and adapted to secure the tether based on a magnetic field. An actuator attaches to the magnet for disposing the magnet out of magnetic communication with the tether release for disengaging the tether from the tether release, allowing the buoy to surface and draw an attached trap line to allow recovery of the trap.

The delayed release device for a buoy engaged with an underwater lobster trap, operates with a first magnet securing a buoy, where the buoy is tethered to a deployed lobster trap, and a second magnet securing the first magnet based on a magnetic field between the magnets sufficient to overcome the buoyancy of the buoy and retain the buoy submerged. A displacement actuator in communication with the second magnet retracts the second magnet in response to a predetermined condition for drawing the second magnet distal from the first magnet for releasing the buoy when the magnetic field diminishes.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of an ocean species harvesting environment suitable for use with configurations herein;

FIG. 2 is a schematic diagram of an ocean species harvesting apparatus with the buoy release device in the underwater environment of FIG. 1;

FIGS. 3A-3D show the tether release of FIG. 2 in incremental stages of operation;

FIGS. 4A-4B are a cutaway view of a configuration of the buoy release device;

FIG. 5 is a perspective view of the device internals inside the housing of FIGS. 1-4D;

FIG. 6 is a block diagram of a control circuit in FIG. 5;

FIG. 7 is a perspective view of the buoy release device as in FIGS. 1-6; and

FIGS. 8A and 8B are screen renderings for a mobile device app responsive to the control circuit of FIG. 6,

### DETAILED DESCRIPTION

The description below presents an example of a particular configuration of the buoy release device for selective release of a lobster trap buoy at a time or signal designated by the harvester. Rather than constant flotation during trap operation for gathering the harvested species, the buoy remains submerged, proximate to the trap such that a buoy tether is not extending to the ocean surface, and presenting a hazard for swimming species, until just prior to harvesting.

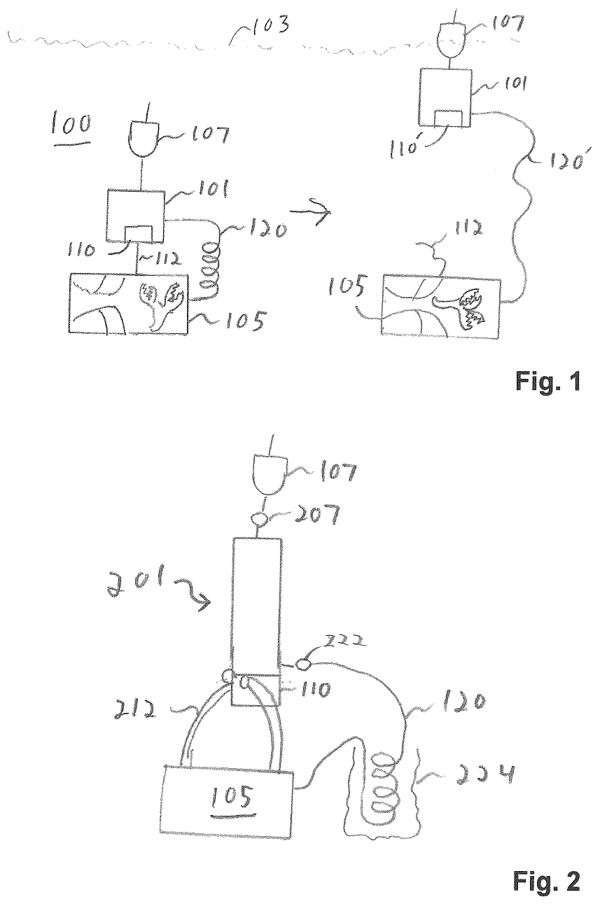

FIG. 1 is a context diagram of an ocean species harvesting environment 100 suitable for use with configurations herein. A buoy release device as described below is configured for use with an underwater ocean species harvesting apparatus such as that used for lobsters, commonly referred to as a “lobster trap.” Similar harvesting devices such as for crab, shrimp, or other suitable passive capture device may also be used with the disclosed approach. Referring to FIG. 1, a buoy release device 101 for an underwater harvesting apparatus 105 includes a tether release 110 securing a tether 112 between a buoy 107 and a submersible harvesting containment 105. In an example arrangement, a magnet disposed in magnetic communication with the tether release 110 is adapted to secure the tether 112 based on a magnetic field. A magnetic coupling between the tether release 110 and an actuator retains the tether release in a closed position. The actuator is adapted to draw the magnet distal from the magnetic coupling for reducing the magnetic field to release the tether release 110. At a prescribed time or event, a control circuit actuator attached to the magnet activates for disposing the magnet out of magnetic communication with the tether release for disengaging the tether 112 from the tether release 110′ as the magnetic field diminishes. The untethered buoy 107 and attached device 101 then float to the surface 103, while a recovery rope 120, attached between the harvesting appliance 105 and the device 101 unwinds to sufficient length 120′ to allow recovery of the trap and contents. In a particular configuration, the device 101 may be fulfilled by a Resurfacing Oceanic Locator, or ROL, discussed further below.

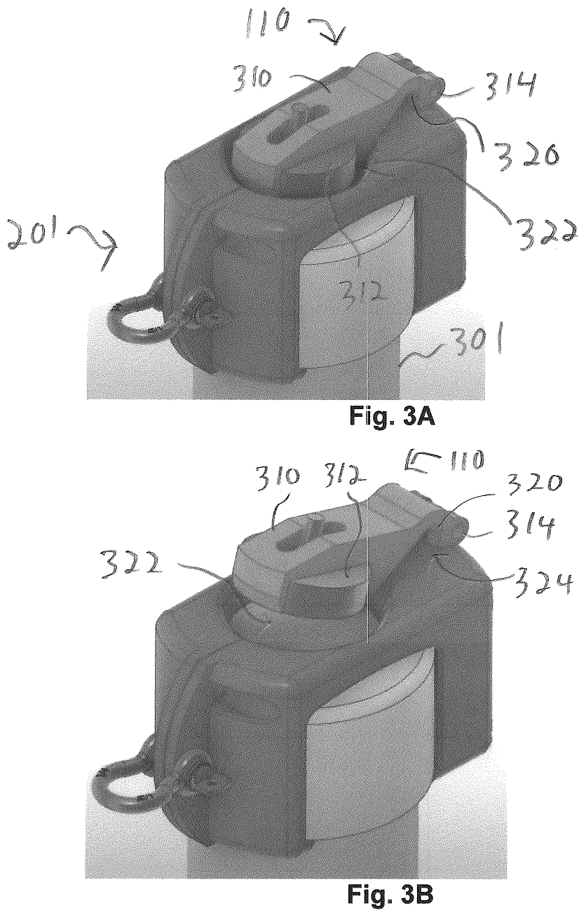

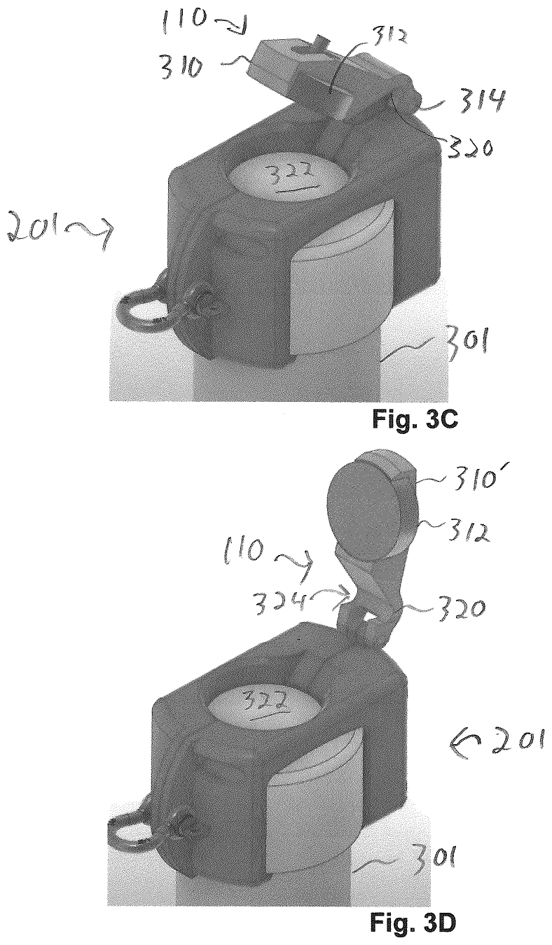

FIG. 2 is a schematic diagram of the ocean species harvesting apparatus with the buoy release device in the underwater environment of FIG. 1. Referring to FIGS. 1 and 2, in an example configuration, a buoy shackle 207 is adapted to engage the buoy 107 and attach the buoy 107 to the buoy release device 201. When deployed underwater, the buoy 107 imposes an upward bias against the tether 112 upon submersion of the device 201, In the example of FIG. 2, the tether takes the form of a bridle 212 forming a closed loop with opposed ends of the trap 105. The tether 112 defines the bridle 212 attached to the submersible harvesting containment 105 (trap) for forming a closed loop. A receptacle on the device 201 housing engages the tether along the closed loop, discussed below in FIGS. 3A-3D. The buoy 107 is adapted to surface upon release from the interference fit with the bridle 212.

Once the buoy 107 releases, a trap shackle 222 on the device 201 housing remains engaged with the recovery rope 120, where the recovery rope 120 attaches between the housing and the submersible harvesting containment. In contrast to the tether 112, the recovery rope 120 has a length based on allowing the buoy 105 and device 201 to float to the surface 103.

To facilitate, the recovery rope 120 resides in a rope containment 224, such that the rope containment 224 arranges the recovery rope 120 in a coiled or ordered manner to pay out the recovery rope in response to a surfacing of the buoy 107 and avoid tangling or knotting of the unwinding rope 120′.

FIGS. 3A-3D show the tether release of FIG. 2 in incremental stages of operation. Referring to FIGS. 1-3D, the tether release 110 is defined by a lever 310 and a hinge 314 attached to the housing 301. The lever 310 defines a receptacle 320 from a recession or groove on an underside adjacent an end surface 322 of the housing 301. The receptacle 320 is sized for receiving the tether 212 in an interference fit when the lever 310 is in a closed position. A magnetic element 312 forms magnetic communication with the end surface such that the lever 310 forms an interference fit with the tether based on the magnetic communication at a pinch point 324. A magnetic element within the housing 301 draws the magnetic element 312 against the end surface 322; the magnetic element 312 need only be ferrous metal or otherwise responsive to the magnetic field; alternatively, it may be a magnet of opposed polarity to increase magnetic attraction. The tether 212 engages in the receptacle 320 and need not be frictionally secured because the tether forms a closed loop with the trap (harvesting apparatus) 105; alternatively, a pinching, compression or friction fit may be attained based on the diameter of the tether 212 and an inner diameter of the receptacle 320.

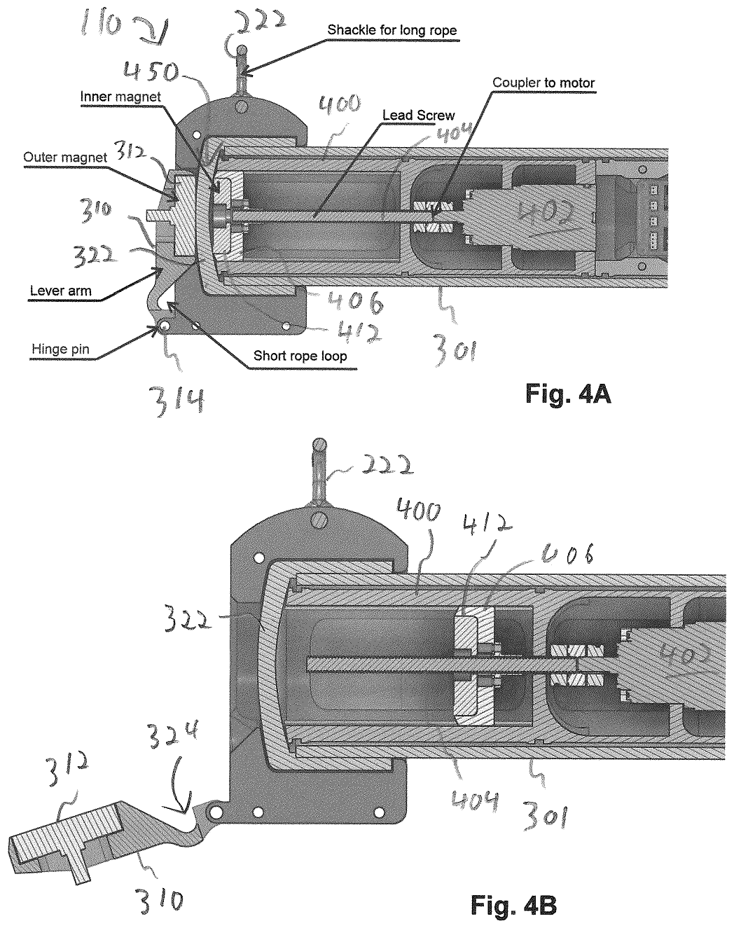

Referring to FIG. 3B, the tether release 110 is adapted to hingedly pivot for disengaging the tether 212 when the magnetic communication with the lever diminishes, discussed further below in FIGS. 4A-4B. In FIG. 3C, the lever 310 attains about a 45 degree opening with respect to the end surface 322, and the receptacle 320 is open sufficiently to release the tether 112. In FIG. 3D, the receptacle 320 depicts a void in an open position upon hinged release responsive to withdrawal of the magnetic field, which allows the tether 112 to freely disengage and release the housing 201 and attached buoy 107 to rise to the surface. Recall that a typical orientation would dispose the end surface 322 facing downward, toward the trap 105 and ocean bottom, and restrained by the tether 212 against the force of the buoy 107 and prevented from surfacing until lever 310′ releases.

FIGS. 4A-4B are a cutaway view of a configuration of the buoy release device. Referring to FIGS. 1-4B, the housing 301 is a hermetically sealed enclosure for protecting the electronics and actuator within, packaged in an inner frame 400. In an example arrangement, the housing 301 may be formed from stock, extruded members such as 3″ PVC pipe. Within the housing 301, an actuator 402 drives a rotary shaft 404. A second magnet, or release magnet 412, is in threaded communication with the rotary shaft 404 via a threaded member 406 for disposing the magnet distal from the magnetic element 312 on the tether release 110. Upon receipt of a release signal, the actuator 402, typically a battery powered motor, rotates the shaft 404 to withdraw the release magnet 412 out of communication with the magnetic member 312, as shown in FIG. 4B.

As the lever 310 is hingedly attached to the end side 322 of the housing 301, the actuator 402 and rotary shaft are disposed within the housing for rotation in response to a predetermined time or control signal to release the lever 310. The housing is hermetically sealed, and further includes a receiver, for communicating with a mobile device application (app). No watertight mechanical seals or plugs are needed since the actuation medium is a magnetic field 450 passing thought the watertight end surface 322.

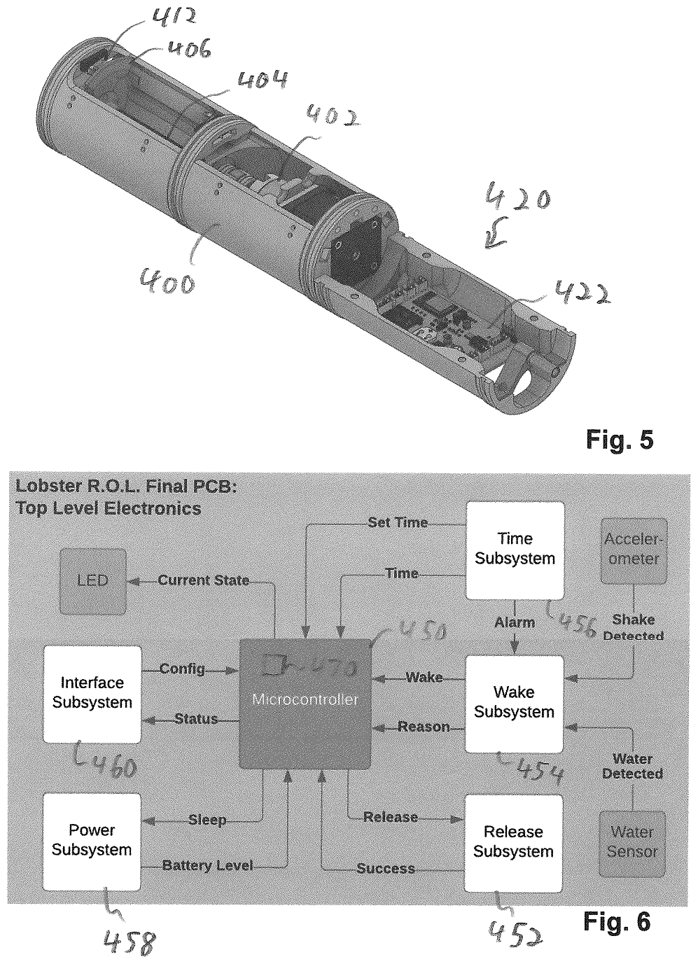

FIG. 5 is a perspective view of the device internals inside the housing of FIGS. 1-4D. Referring to FIGS. 1-5, the inner frame 400 includes the actuation mechanism of the actuator 402, shaft 404, threaded member 406 and release magnet 412. The control circuit 422 occupies the opposed end from the end surface 322, and resides adjacent a battery compartment 420, all sealed withing the watertight housing 301.

FIG. 6 is a block diagram of the control circuit 422 in FIG. 5. Referring to FIGS. 1-6, the control circuit 450 includes a release subsystem 452, a wake subsystem 454, a time subsystem 456, a power subsystem 458 and an interface subsystem 460. Briefly, the release subsystem 452 implements the release signal 453 to drive the actuator 402 to dispose the release magnet 412 away from the outer magnetic element 312 for release of the tether 212. The wake subsystem 454 maintains control circuit logic 470 in a low power mode until either 1) a release time interval has elapsed, 2) a shaking of the device signals a user intending to communicate via a remote device, or 3) water infiltration is detected. The time subsystem 456 stores the intervals governing release, and issues a wake signal when a user set time to release the buoy elapses. The power subsystem manages power-in the example configuration, a smaller ˜3V coin cell powers the microcontroller for identifying/issuing the release signal 453, and engages a larger ˜12v battery with sufficient power to drive the actuator 402. Battery life is expected to be several years or seasons, however the housing 301 has a threaded end opposed from the end surface 322 for access and removal of the frame 400.

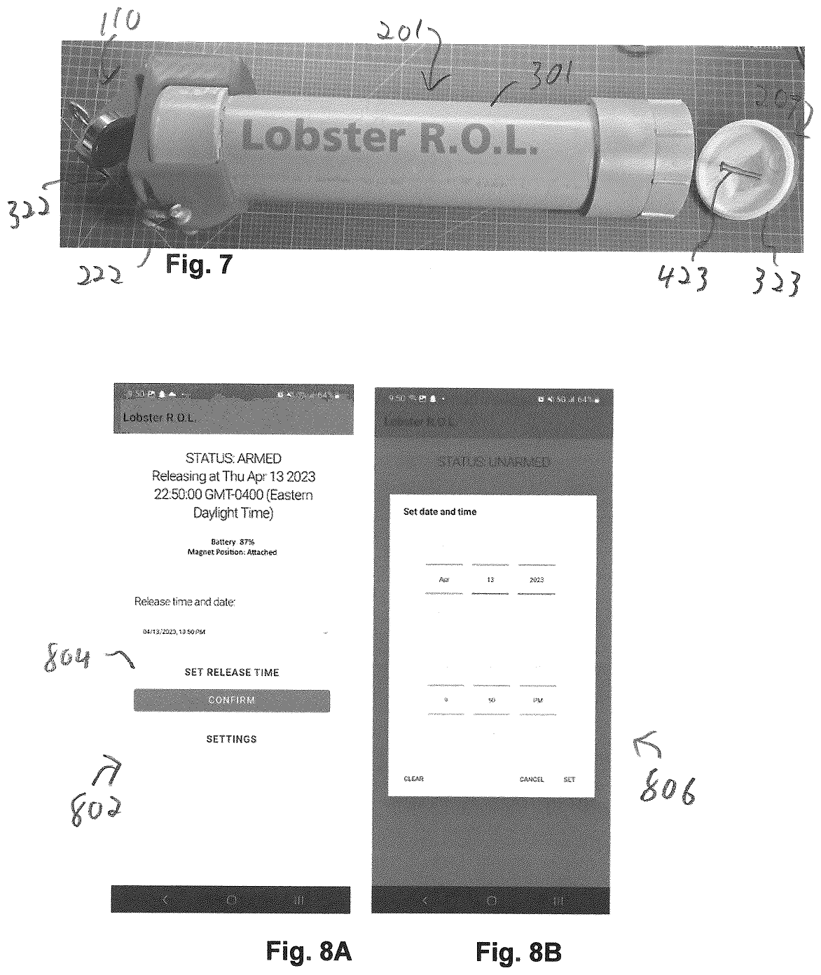

FIG. 7 is a perspective view of the buoy release device as in FIGS. 1-6. Referring to FIGS. 1-7, the buoy release device 201 includes the housing 301 having the end surface 322 where the tether release 110 resides. The trap shackle 222 attaches on an annular longitudinal side nearby, and the buoy shackle 207 attaches to a sealing lid 323 or elsewhere on the housing 301. An optical tube 423 allows user signaling of status from the control circuit 422. The control circuit 422 include an optical indicator such as an LED, where the optical indicator is disposed in the watertight enclosure of the housing. The optical tube emanates from the optical indicator and engages with an optical window on the threaded end 323 of the housing 301 for transmission of an optical signal. For example, the user might agitate (“shake”) the device upon retrieval from storage to wake the control circuit 422 for programming a release time via the app, now discussed with respect to FIGS. 8A and 8B.

FIGS. 8A and 8B are screen renderings for a mobile device app responsive to the control circuit of FIG. 6, Referring to FIGS. 1-8B, FIG. 8A depicts a screen rendering 802 for a selection 804 to set a release time for actuating the tether release 110. In FIG. 8B, a timer screen 806 allows entry of a date and time for actuation of the tether release 110. The interface subsystem 460 maintains a wireless interface via any suitable medium for setting an absolute or relative release time, immediate release commands, and other settings.

In an alternate approach, the inner magnet moves transverse to the outer magnet holding the buoy, to break the magnetic linkage in a shear motion, rather than an axial withdrawal. The inner magnet is attached to a lead screw which is connected to n actuator motor. By rotating the lead screw, the stepper motor can displace the inner magnet laterally. The outer magnet is constrained laterally with a ring that surrounds it and is glued to the outside of the box. The outer magnet can still be pulled vertically upwards. By laterally shifting the inner magnet while keeping the outer magnet in place, the magnetic attraction force is broken. This leaves the buoy free to rise to the surface. The shear force required to separate the magnets horizontally in this way, rather than pulling them apart vertically, is greatly reduced. This allows the stepper motor to easily separate the magnets while only consuming around 3 Watts.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A buoy release device for an underwater harvesting apparatus, comprising:
a tether release securing a tether between a buoy and a submersible harvesting containment;
a magnet disposed in magnetic communication with the tether release and adapted to secure the tether based on a magnetic field; and
an actuator attached to the magnet for disposing the magnet out of magnetic communication with the tether release for disengaging the tether from the tether release.

2. The device of claim 1 further comprising a magnetic coupling between the tether release and the actuator, the actuator adapted to draw the magnet distal from the magnetic coupling for reducing the magnetic field to release the tether release.

3. The device of claim 1 wherein the tether release is defined by a lever hingedly attached to a housing, the lever forming an interference fit with the tether based on the magnetic communication.

4. The device of claim 3 wherein the tether release is adapted to hingedly pivot for disengaging the tether when the magnet is drawn out of magnetic communication with the lever.

5. The device of claim 3 further comprising a buoy shackle adapted to engage a buoy, the buoy imposing an upward bias against the lever upon submersion of the housing, the buoy adapted to surface upon release of the tether from the interference fit.

6. The device of claim 3 further comprising a trap shackle on the housing, the trap shackle adapted to engage a recovery rope, the recovery rope attached between the housing and the submersible harvesting containment.

7. The device of claim 6 further comprising the rope and a rope containment, the rope containment arranging the recovery rope and adapted to pay out the recovery rope in response to a surfacing of the buoy.

8. The device of claim 3 further comprising a rotary shaft, the rotary shaft driven by the actuator, the magnet in threaded communication with the rotary shaft for disposing the magnet distal from the tether release.

9. The device of claim 8 wherein the lever is hingedly attached to an end side of the housing, the actuator and rotary shaft disposed within the housing, the housing hermetically sealed, further comprising a receiver, the actuator responsive to the receiver for receiving a release signal.

10. The device of claim 8 wherein the lever further defines a receptacle, the receptacle sized for receiving the tether in an interference fit when the lever is in a closed position, and the receptacle having a void in an open position upon hinged release responsive to withdrawal of the magnet.

11. The device of claim 10 wherein the tether defines a bridle attached to the submersible harvesting containment for forming a closed loop, the receptacle engaging the tether along the closed loop.

12. The device of claim 9 further comprising:
an optical indicator, the optical indicator disposed in a watertight enclosure within the housing; and
an optical tube, the optical tube emanating from the optical indicator and engaging with an optical window on the housing for transmission of an optical signal.

13. The device of claim 3 wherein the housing is formed from stock commodity PVC (polyvinyl chloride) members.

14. The device of claim 1 further comprising a control circuit, the actuator responsive to the control circuit for receiving a release signal to withdraw a release magnet for abating the magnetic field.

15. The device of claim 14 wherein the control circuit further comprises an antenna, the antenna operable for transmitting and receiving in a submerged environment.

16. A delayed release device for a buoy engaged with an underwater lobster trap, comprising:
a first magnet securing a buoy, the buoy tethered to a deployed lobster trap;
a second magnet securing the first magnet based on a magnetic field; and
a displacement actuator in communication with the second magnet for retracting the magnet in response to a predetermined condition for drawing the second magnet distal from the first magnet for releasing the buoy when the magnetic field diminishes.

17. The device of claim 16 wherein the actuator is configured to retract the magnet based on a predetermined time.

18. The device of claim 16 wherein the actuator includes a drive screw having a threaded engagement with the second magnet, the drive screw responsive to rotation for retracting the second magnet.
